(19) United States
(12) Patent Application Publication
(10) Pub. No.: US 2016/0048774 A1
(43) Pub. Date: Feb. 18, 2016

(54) METHOD AND APPARATUS FOR LOCALIZED MANAGEMENT OF FEATURE LICENSES

(71) Applicant: ARRIS Enterprises, Inc., Suwanee, CA (US)

(72) Inventors: David B. Prickett, San Diego, CA (US); Jinsong Zheng, San Diego, CA (US)

(21) Appl. No.: 14/461,536

(22) Filed: Aug. 18, 2014

(51) Int. Cl. G06Q 10/00

(52) U.S. Cl. CPC G06Q 10/00; G06Q 2220/18

(57) ABSTRACT

Methods and systems are provided for managing feature licenses for pools or groups of devices. In an embodiment, a method of licensing features for a device in a license pool or group includes receiving, at the device, a license capacity request; determining, based on the reply to the license capacity request, if the device in the license pool or group is compliant with the feature license configuration; if the device is noncompliant with the feature license configuration: transmitting a generate license request message having a desired feature license configuration; receiving a feature license request from the device; and updating the noncompliant device with a compliant feature license.

### TECHNICAL FIELD

The present disclosure is related generally to systems and methods for managing device licenses, and in particular to a system and method for managing individual device feature licenses for one or more devices in a license pool.

### BACKGROUND

Feature licensing has been increasingly used to control the internal functions of electronic devices after they are purchased by customers. Feature licensing allows flexibility for customers to acquire devices with less upfront cost and pay later for additional functions and capacity. A feature license for a specific device controls which internal functions of that device are enabled. When an internal function has a range of capacity, a feature license can also control the level of capacity at which the function should perform. For example, a video encoder may support high efficiency video coding (HEVC) and a maximum of 64 video streams. When the encoder has a feature license that does not enable HEVC and limits the number of video streams to 16, the encoder does not perform HEVC and can only encode up to 16 video streams. However, when the encoder has or obtains a feature license that enables HEVC and limits the number of video streams to 48, the encoder will do HEVC encoding on up to 48 video streams. To make sure that a feature license can only be used by a specific device, the feature license is commonly cryptographically bound to the unique identification of the device.

The application of a feature license to individual devices is typically dependent upon the device supporting the capability of allowing a user to apply the license via a Graphical User Interface (GUI). In many application scenarios, devices are created without such an interface. In addition, devices may have configuration rules that require that each device within an installed group be feature-licensed in exactly the same way. Finally, if many devices require a unique or individual feature license, it creates an undue operational load. In order to allow for such devices to be licensed without creating an undue operational load, licenses must be managed by a feature license management system local to those devices.

### SUMMARY OF THE EMBODIMENTS

Described herein are methods and systems for managing feature licenses for pools or groups of devices. Such devices in the pools or the pools themselves may include one or more of the following: require a feature license, do not have a license user interface available to the user of the device, require that all devices in the group be licensed in a homogeneous fashion, and/or feature licensing of a large number of devices create an unsupportable operational burden.

In a first aspect, a method of licensing features for a device in a license pool or group is disclosed. The method includes receiving, at the device, a license capacity request; determining, based on the reply to the license capacity request, if the device in the license pool or group is compliant with the feature license configuration; if the device is noncompliant with the feature license configuration: transmitting a generate license request message having a desired feature license configuration; receiving a feature license request from the device; and updating the noncompliant device with a compliant feature license. In an embodiment of the first aspect, receiving a feature license includes receiving a new or modified feature license. In an embodiment of the first aspect, a user provides the new or modified feature license configuration. In an embodiment of the first aspect, a feature license management system provides the feature license configuration to the device. In an embodiment of the first aspect, the generate license request message includes one or more of a list of features to be licensed and a cryptographic signature of the generate license request message. In an embodiment of the first aspect, the list of features to be licensed includes features selected from Boolean and/or capacity features. In an embodiment of the first aspect, the method further includes informing a user that there is a feature license request to be processed. In an embodiment of the first aspect, the feature license request is processed by a centralized licensing system. In an embodiment of the first aspect, the method further includes generating the feature license by a centralized licensing system. In an embodiment of the first aspect, the method further includes transmitting the feature license to a feature license management system. In an embodiment of the first aspect, the method further includes transmitting the feature license to the device. In an embodiment of the first aspect, the feature license includes one or more of a unique device identifier, a monotonically increasing sequence number, a list of licensed features, and a cryptographic signature of the feature license. In an embodiment of the first aspect, updating the noncompliant device with the feature license includes applying the feature license to enable device operations. In an embodiment of the first aspect, the method further includes transmitting a feature license status from the device to the feature license management system. In an embodiment of the first aspect, the method further includes displaying the feature license status of the device to a user.

In a second aspect, a system is disclosed. The system includes a plurality of devices configured to receive and apply feature licenses; a first server configured to create and store feature license configurations; and a second server configured to generate feature licenses and communicate with the first server to transmit the feature licenses to the plurality of devices. In an embodiment of the second aspect, the plurality of devices is further configured to generate feature license requests. In an embodiment of the second aspect, the plurality of devices is further configured to perform verification of compliance with feature license configurations. In an embodiment of the second aspect, the first server is configured to instruct the plurality of devices to generate feature license requests. In an embodiment of the second aspect, the first server and second server are separate servers. In an embodiment of the second aspect, the first server and second server are one server. In an embodiment of the second aspect, the first server is further configured to receive feature license requests. In an embodiment of the second aspect, the first server is further configured to distribute feature licenses to the plurality of devices.

### BRIEF DESCRIPTION OF THE SEVERAL VIEWS OF THE DRAWINGS

While the appended claims set forth the features of the present techniques with particularity, these techniques, together with their objects and advantages, may be best understood from the following detailed description taken in conjunction with the accompanying drawings of which:

FIG. 1 is a diagram illustrating an example group licensing system;

FIG. 2 is a flowchart of a representative method for creating or modifying a feature license configuration for a license pool;

FIG. 3 is a flowchart of a representative method for determining if a device in a license pool has a current license;

FIG. 4 is a flowchart of a representative method for updating a noncompliant device in a license pool;

FIG. 5 is a diagram illustrating an embodiment of how feature licenses for devices in a pool can be managed; and

FIG. 6 is a diagram illustrating an example computer system that could be used to implement elements of the disclosure.

### DETAILED DESCRIPTION

Turning to the drawings, wherein like reference numerals refer to like elements, techniques of the present disclosure are illustrated as being implemented in a suitable environment. The following description is based on embodiments of the claims and should not be taken as limiting the claims with regard to alternative embodiments that are not explicitly described herein.

Managed feature licensing allows for efficient license configuration, generation and distribution of feature licenses to a large pool or group of devices. This eases the operational burden associated with licensing devices individually, and guarantees that all devices in the pool or group are licensed in a homogeneous fashion.

Managed licensing for a pool or group of devices poses two challenges: (1) the required feature license configuration for the group must be created and maintained, and (2) the feature license configuration for all devices in a group must be monitored in order to confirm that the license conforms with the required configuration for all devices in the group.

In accordance with embodiments of the present disclosure, the following definitions may be used:

Device Feature: An internal function of an electronic device.

Feature Descriptor: A data structure that contains a feature ID and a feature type (either Boolean or integer), and a feature value if the feature type is integer. The feature value of an integer type feature is the quantity of the feature.

Feature License Configuration: A list of feature descriptors, each for a different feature, targeted to a pool or group of homogenously licensed devices. For a Boolean type feature, the setting is either on or off. For an Integer type feature, the setting is an integer indicating the capacity of the feature.

Feature License: A file that contains, among other things, the identification of a licensed device, feature license configuration, a monotonously increasing sequence number and a signature that can only be generated by a central licensing system.

Managed Device Group: A group devices that work together to provide certain functionality as a whole. A device group has a globally unique group ID

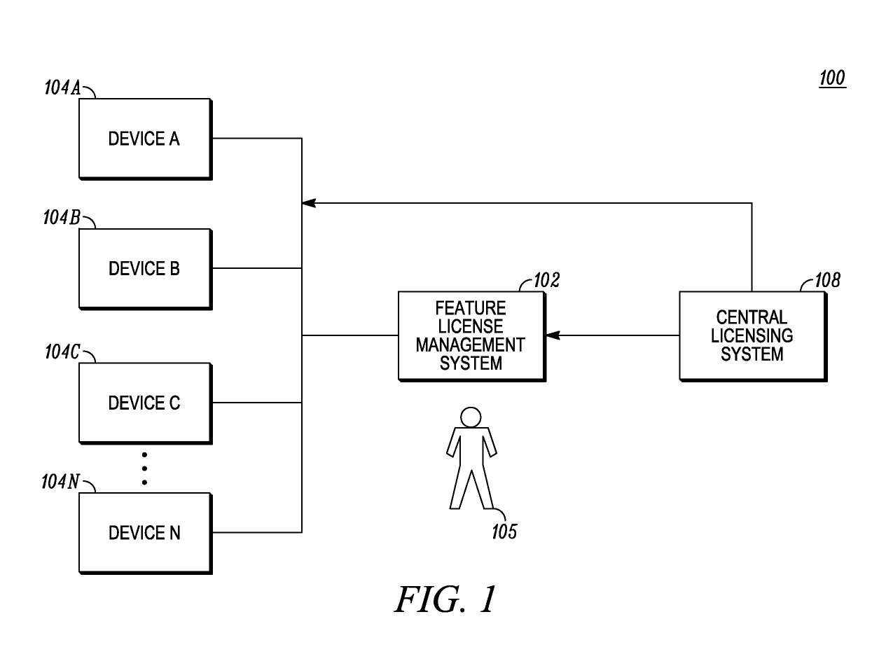

FIG. 1 depicts a simplified diagram of a license management system 100 according to one embodiment. License management system 100 includes a feature license management system 102, a central licensing system 108 and one or more devices 104A-104N to be licensed. The feature license management system 102 can be used to manage the licensing of devices 104A-104N, and can typically be implemented as an application executing on a computer or similar device, as discussed further below.

In some embodiments, the feature license management system 102 is responsible for providing a method for generation and storage of the feature license configuration. In addition, the feature license management system 102 may be responsible for sending the feature license configuration to each device 104A-104N, receiving and storing a license request for each device 104A-104N, and then informing a user 105 that that license requests are ready to uploaded to the central licensing system 108 for generation. Once the user 105 has generated the license using the central licensing system 108, and loaded the resultant licenses to the feature license management system 102, the feature license management system 102 is responsible for distributing the licenses to the devices 104A-104N, and then receiving license status from each device 104A-104N.

In some embodiments, the feature license management system 102 is configured to maintain license configuration for pools or groups of licensed devices 104, including: support configuration/update/storage of a list of all licensed devices in a pool and support configuration/update/storage of a feature license configuration for the pool. As described herein, all of the licensed devices in a pool shall be licensed for the same capacity as defined by the pool license capacity that is configured for the pool by the feature license management system 102.

In some embodiments, the feature license management system 102 is configured to query all licensed devices in a pool to determine current license capacity, gather license requests for all licensed devices that do not match the pool license capacity, signal users that a license updater is required, allow a user to apply/store updated licenses in feature license management system 102, and distribute updated licenses to licensed devices the pool.

Additionally, license management system 100 may include networks 110 or network connections that allow devices 104A-104N, feature license management system 102 and/or central licensing system 108 to communicate with each other. These networks 100 may include the Internet, various intranets, etc. and may include wired links and wireless links.

In some situations the presence of a local license management system 102 is feasible, due to financial, technical or legal reasons, and individual licensing of devices 104A-N is not feasible, due to technical or operational reasons. In such situations, devices 104A-N are interconnected with each other (e.g., via a device network 110) for licensing purposes. It is desirable for networks 110 in such situations to be highly reliable, and may be separate from other networks (not illustrated) that the devices are connected to.

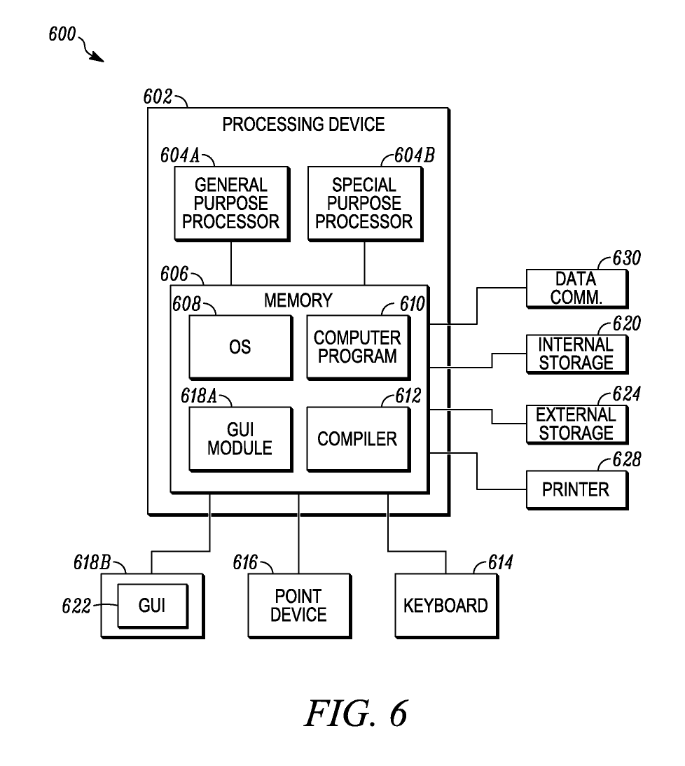

Devices 104A-N, feature license management system 102 and/or central licensing system 108 may each include a set of processors and a non-transitory computer readable storage medium (memory), discussed in further detail in FIG. 6. The memory may store instructions, which the set of processors may execute to carry out various embodiments described herein. Devices 104A-N, feature license management system 102 and/or central licensing system 108 may each may include a number of computer devices that share a domain.

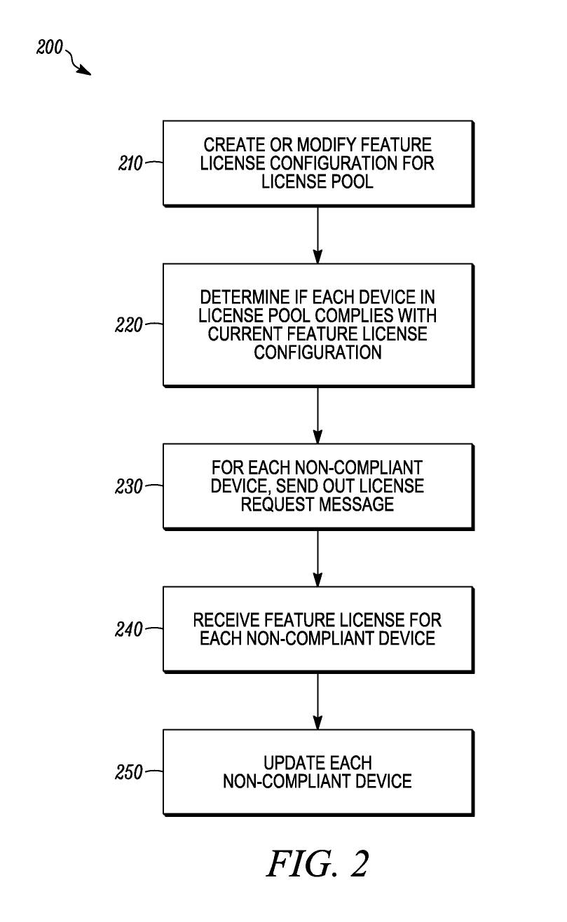

FIG. 2 is a flowchart of a representative method 200 for creating or modifying a feature license configuration for a license pool. In block 210, a system, such as system 100, creates or modifies a feature license configuration for a license pool. In some embodiments, a user 105 creates or modifies the feature license configuration.

For example, the user 105 may select a pool feature license configuration definition from the feature license management system 102. The feature license management system 102 may display a pool license capacity configuration screen, with the current configuration, if any. The user 105 then selects feature values for pool feature license configuration. The feature license management system 102 may display a pool feature license configuration screen, with the current configuration, if any. The user 105 then selects a function to store the new configuration. In response, the feature license management system 102 may store the new pool feature license configuration and optionally alert the user 105 that the change will result in updates the licensed device pool.

In block 220, the system determines if each device 104 in the license pool is compliant with the current feature license configuration (e.g., from block 210). At block 230, for each noncompliant device, the system transmits a license request message. In some embodiments, the license request message includes the feature license configuration defined for the pool.

For example, the feature license management system 102 may detect a change in the pool license capacity and thereafter it may send license capacity requests to licensed devices in the pool. The licensed devices may respond with current license capacity, if any. Alternatively, the feature license management system 102 may detect that new licensed devices have been configured into a pool. The feature license management system 102 may then send license capacity requests to the new licensed devices in the pool.

If a licensed device's current licensed capacity does not match the pool license capacity, the feature license management system 102 may alert the user that license requests are being created and may send a Generate License Request Message to the licensed devices in the pool. In some embodiments, the licensed devices process the Generate License Request Message and replies to the feature license management system 102 with a license request. Thereafter, the feature license management system 102 stores the received license requests and alerts the user 105 that new licenses must be obtained from central licensing system 108.

At block 240, the system receives a feature license for each noncompliant device. At block 250, each noncompliant device is updated to make it compliant.

In some embodiments, the feature license management system 102 detects the new or updated feature license and instructs the licensed devices to apply the feature license. The licensed devices may set the status of the license application as successful and send a reply message to the feature license management system 102. Thereafter, the feature license management system 102 updates the status of the license for the licensed device and optionally alerts the user 105 of the updated status. Alternatively, the feature license management system 102 updates the status of the license for the licensed device, alerts the user of failure with one or more reasons for the failure.

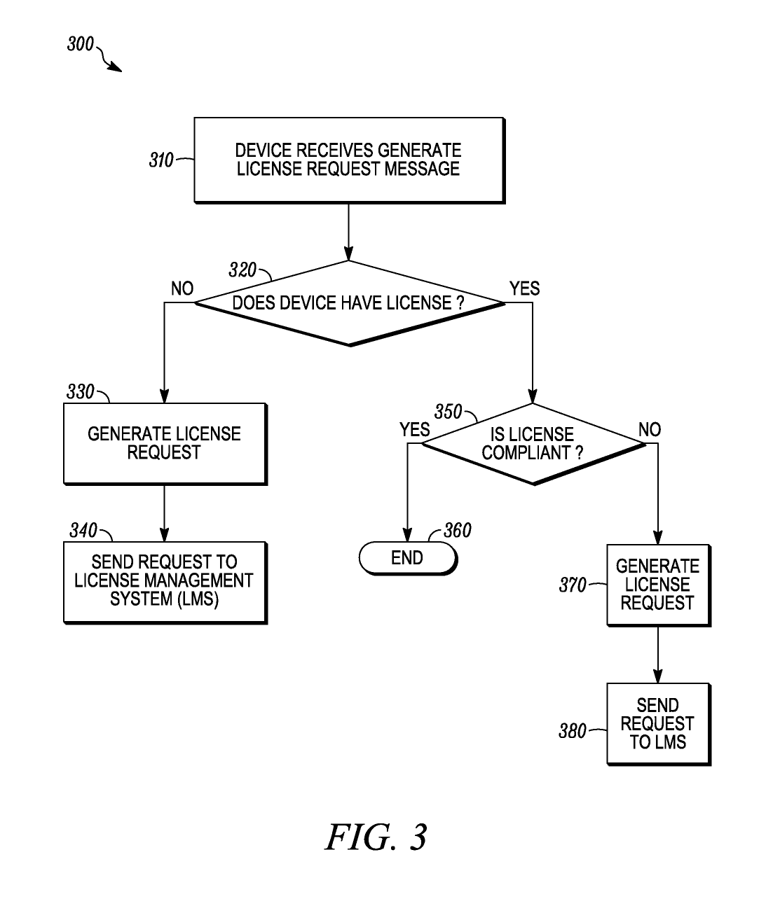

FIG. 3 is a flowchart of a representative method 300 for determining if a device in a license pool has a current license. At block 310, a device receives a Generate License Request Message.

At block 320, the system determines if the device has a current feature license. In some embodiments, the system determines the device status by querying the device. If, at block 320, it is determined the device does not have any feature license, then the device will generate a license request at block 330. Thereafter, the system will transmit the request to the license management system (LMS) at block 340.

If, at block 350, it is determined that the device does have a feature license, the system will check to see if the feature license is compliant (e.g., current). If the license is compliant, at block 360, the process ends.

If it is determined that the device does have a feature license that is not compliant, at block 370, the system generates a license request. Possible reasons for noncompliance include that the current content of the feature license does not match the feature license configuration from the Generate License Request Message. For example, in some instances, one or more features would require additional capacity or functionality, also known as an upgrade. Alternatively, in some instances, one or more features would require less capacity or functionality, also known as a downgrade. Possible reasons for requiring less capacity include that the system operator has a desire to reduce license capacity due to under-subscription of the licensed function, and to then move the license capacity to a system that is over-subscribed or close to over-subscription. In some embodiments, upgrades and downgrades can be performed at the same time. Thereafter, at block 380, the system transmits the request to LMS.

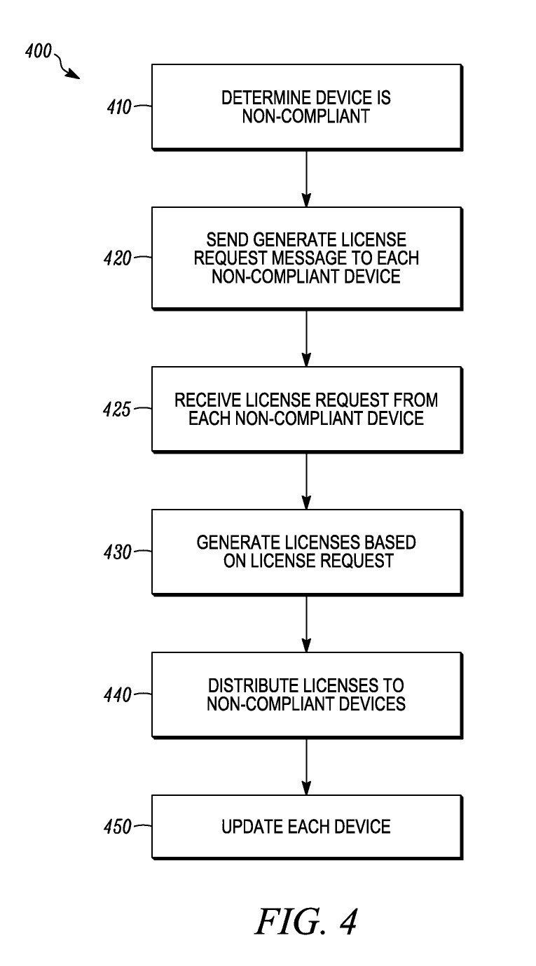

FIG. 4 is a flowchart of a representative method 400 for updating a noncompliant device in a license pool. In block 410, the system determines that one or more devices in a license pool are noncompliant. At block 420, the system receives a feature configuration license request from each noncompliant device.

At block 430, the system generates feature configuration licenses for each of the noncompliant devices. At block 440, the system distributes the generated licenses to each of the noncompliant devices. In some embodiments, each noncompliant device receives and applies the license update, and informs the LMS that the license had been successfully applied. Thereafter, at block 450, each device receiving a compliant feature configuration license is updated.

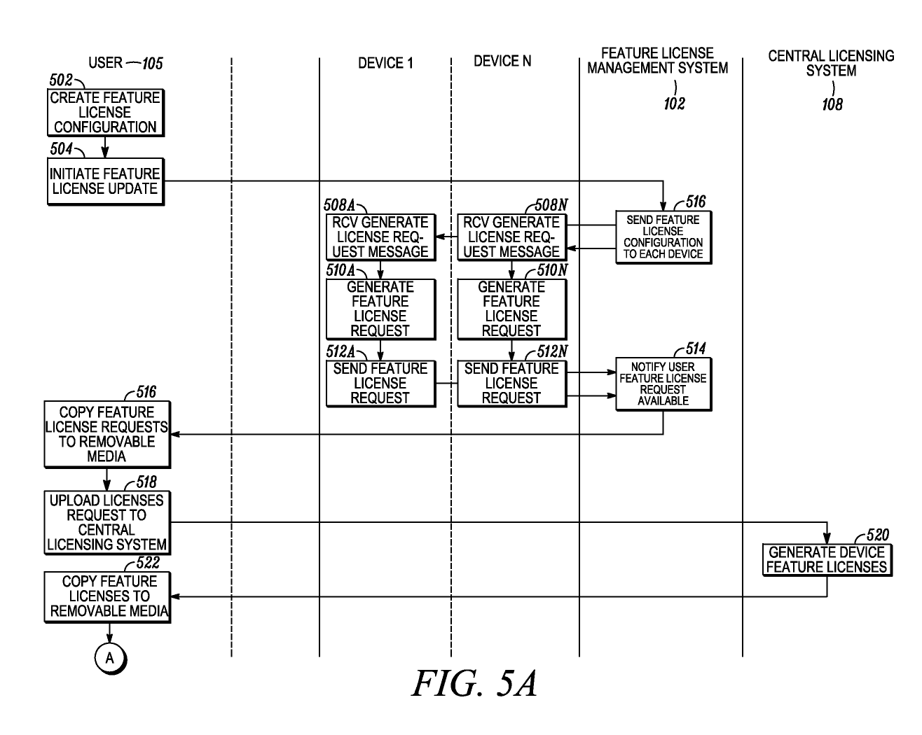

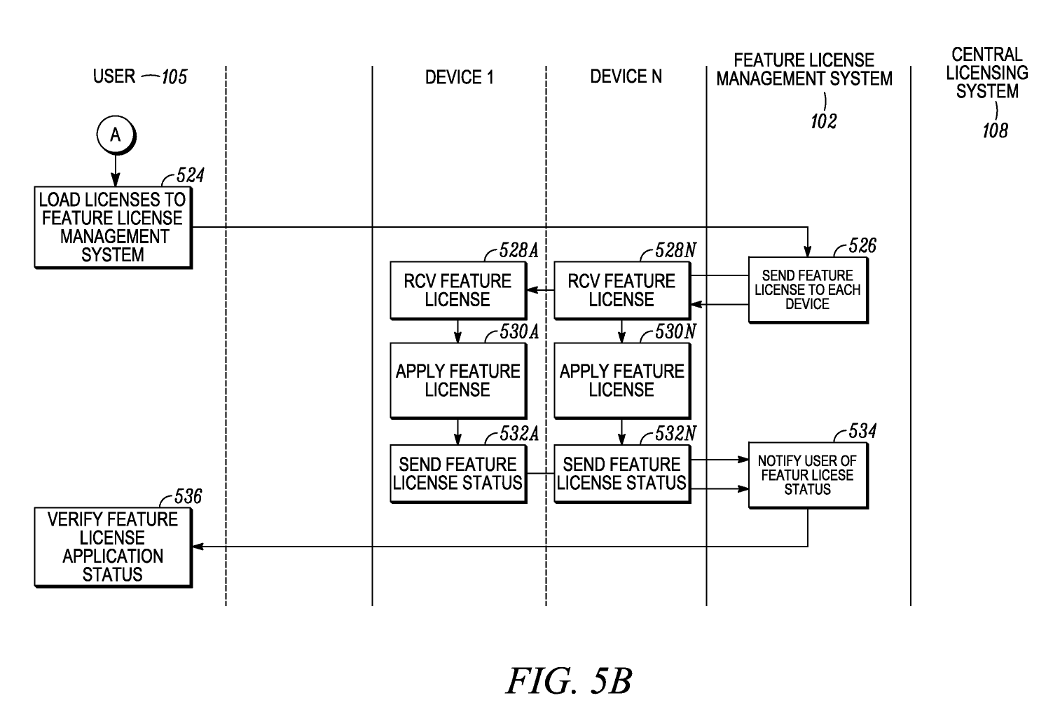

FIG. 5A is a diagram illustrating an example of how feature license requests are generated for a number of devices. When a new feature license configuration is defined by the user 105 as shown in block 502, the user 105 then initiates a license update, as shown in block 504, for all of the devices 104A-104N to be licensed.

The feature license manager 102 then connects to each device 104A-104N to send the Generate License Request Message, as shown in block 506, to each device 104A-104N. Each device 104A-104N receives the Generate License Request Message as shown in blocks 508A-508N. Each device 104A-104N then creates a feature license request, as shown in blocks 510A-510N. Each device 104A-104N then connects to the feature license manager 102 to send the feature license request to the feature license manager 102, as shown in blocks 512A-512N. The feature license manager 102 then informs the user 105 that license requests are available, as shown in block 514.

The user 105 then copies the license requests to removable media (e.g., USB drive), as shown in block 516. The user 105 then uploads the feature license requests to the central licensing system 108, as shown in block 518. The central licensing system 108 generates a feature license for each device per respective feature license request, as shown in block 520. The user 105 then copies the feature licenses to removable media, as shown in block 522.

FIG. 5B is a diagram illustrating an example of feature license distribution for a number of devices. As shown in block 524, the user 105 then loads the feature licenses to the feature license management system 102. The feature license management system 102 then connects to each device 104A-104N and sends the feature license to its corresponding device 104A-104N, as shown in block 526. Each device 104A-104N receives the feature license, as shown in block 528A-528N, applies the feature license, as shown in block 530A-530N, and then connects to the feature license manager 102 to send feature license status, as shown in block 532A-532N.

The feature license management system then notifies the user of the feature license application status, as shown in block 534. At block 536, the user 105 can verify the feature license application status.

FIG. 6 is a diagram illustrating an example computer system that could be used to implement elements of the disclosure including, devices 104, feature license management system 102 and central licensing system 108. The computer system 600 includes a processing device such as a computer 602, which comprises a general purpose hardware processor 604A and/or a special purpose hardware processor 604B (hereinafter alternatively collectively referred to as processor 604) and a memory 606, such as random access memory (RAM). The computer 602 may be coupled to other devices, including input/output (I/O) devices such as a keyboard 614, a mouse device 616 and a printer 628.

In one embodiment, the computer 602 operates by the general purpose processor 604A performing instructions defined by the computer program 610 under control of an operating system 608. The computer program 610 and/or the operating system 608 may be stored in the memory 606 and may interface with the user and/or other devices to accept input and commands and, based on such input and commands and the instructions defined by the computer program 610 and operating system 608 to provide output and results.

Output/results may be presented on the display 622 or provided to another device for presentation or further processing or action. In one embodiment, the display 622 comprises a liquid crystal display (LCD) having a plurality of separately addressable pixels formed by liquid crystals. Each pixel of the display 622 changes to an opaque or translucent state to form a part of the image on the display in response to the data or information generated by the processor 604 from the application of the instructions of the computer program 610 and/or operating system 608 to the input and commands. Other display 622 types also include picture elements that change state in order to create the image presented on the display 622. The image may be provided through a graphical user interface (GUI) module 618A. Although the GUI module 618A is depicted as a separate module, the instructions performing the GUI functions can be resident or distributed in the operating system 608, the computer program 610, or implemented with special purpose memory and processors.

Some or all of the operations performed by the computer 602 according to the computer program 610 instructions may be implemented in a special purpose processor 604B. In this embodiment, some or all of the computer program 610 instructions may be implemented via firmware instructions stored in a read only memory (ROM), a programmable read only memory (PROM) or flash memory within the special purpose processor 604B or in memory 606. The special purpose processor 604B may also be hardwired through circuit design to perform some or all of the operations to implement embodiments of the present disclosure. Further, the special purpose processor 604B may be a hybrid processor, which includes dedicated circuitry for performing a subset of functions, and other circuits for performing more general functions such as responding to computer program instructions. In one embodiment, the special purpose processor is an application specific integrated circuit (ASIC).

The computer 602 may also implement a compiler 612 which allows an application program 610 written in a programming language such as COBOL, C++, FORTRAN, or other language to be translated into processor 604 readable code. After completion, the application or computer program 610 accesses and manipulates data accepted from I/O devices and stored in the memory 606 of the computer 602 using the relationships and logic that was generated using the compiler 612.

The computer 602 also optionally comprises an external communication device such as a modem, satellite link, Ethernet card, or other device for accepting input from and providing output to other computers. In one embodiment, instructions implementing the operating system 608, the computer program 610, and/or the compiler 612 are tangibly embodied in a computer-readable medium, e.g., data storage device, which could include an internal storage device 620 or external storage device 624 in the form of one or more fixed or removable data storage devices, such as a zip drive, floppy disc drive, hard drive, CD-ROM drive, tape drive, or a flash drive. Further, the operating system 608 and the computer program 610 are comprised of computer program instructions which, when accessed, read and executed by the computer 602, causes the computer 602 to perform the steps necessary to implement and/or use embodiments of the present disclosure or to load the program of instructions into a memory, thus creating a special purpose data structure causing the computer to operate as a specially programmed computer executing the method steps described herein. Computer program 610 and/or operating instructions may also be tangibly embodied in memory 606 and/or data communications devices 630, thereby making a computer program product or article of manufacture according to the invention. As such, the terms “article of manufacture,” “program storage device” and “computer program product” or “computer readable storage device” as used herein are intended to encompass a computer program accessible from any computer readable device or media.

Of course, those skilled in the art will recognize that any combination of the above components, or any number of different components, peripherals, and other devices, may be used with the computer 602.

Although the term “computer” is referred to herein, it is understood that the computer may include portable devices such as cellphones, portable MP3 players, video game consoles, notebook computers, pocket computers, or any other device with suitable processing, communication, and input/output capability.

In view of the many possible embodiments to which the principles of the present discussion may be applied, it should be recognized that the embodiments described herein with respect to the drawing figures are meant to be illustrative only and should not be taken as limiting the scope of the claims. Therefore, the techniques as described herein contemplate all such embodiments as may come within the scope of the following claims and equivalents thereof.

For example, the feature license management system 102 may be configured to monitor licensed devices including transmitting license requests and distributing licenses. In some embodiments, the feature license management system 102 shall support the capability to send a license capacity request message to licensed devices in a pool. The feature license management system 102 shall support the capability to send a Generate License Request Message to licensed devices in the pool. If the feature license configuration for a licensed device pool controlled by a feature license management system 102 is either newly defined or changed, the feature license management system 102 shall send a license capacity request to all licensed devices in the pool.

In some embodiments, if the license capacity currently supported by a licensed device in the pool is different than a level defined in a base license capacity, then the feature license management system 102 shall send a Generate License Request Message containing the feature license configuration to the licensed device. The feature license management system 102 shall periodically request the current license capacity for all licensed devices in a pool.

Additionally, in some embodiments, feature license management system 102 shall support the capability to send a Generate License Request Message containing the pool license capacity to licensed devices in a pool. If the feature license management system 102 detects that a licensed device's current license capacity does not match the pool license capacity, then the feature license management system 102 shall send a Generate License Request Message containing the feature license configuration to the licensed device. If the feature license management system 102 detects that a licensed device's current license capacity does not match the feature license configuration, then the feature license management system 102 shall display a user alert that a license update is needed for that licensed device.

When the feature license management system 102 receives a Generate License Request Message reply containing a license request from a licensed device in a pool, the feature license management system 102 shall store the license request in a user-accessible location. When the feature license management system 102 receives a license request reply containing a license request from a licensed device in a pool, the feature license management system 102 shall display a user alert that a license request has been received from a licensed device in the pool.

In some embodiments, the feature license management system 102 shall support the capability to send feature licenses to licensed devices in a pool, (e.g., via an apply license message). The feature license management system 102 shall support the capability to allow a user to store licenses for licensed devices in a pool. The feature license management system 102 shall support the capability to detect when new license for licensed devices have been stored, based on the date in the license file name. If a new license is detected, then the feature license management system 102 shall send the license to the licensed device defined in a device ID portion of the license file name. The feature license management system 102 shall support the capability to process apply license reply messages received from a licensed device. Lastly, If the feature license management system 102 receives an apply license reply message, then the feature license management system 102 shall display a user alert of the updated license status for the licensed device that the message was received from.

We claim:

1. A method of licensing features for a device in a license pool or group comprising:
receiving, at the device, a license capacity request;
determining, based on the reply to the license capacity request, if the device in the license pool or group is compliant with the feature license configuration;
if the device is noncompliant with the feature license configuration:
transmitting a generate license request message having a desired feature license configuration;
receiving a feature license request from the device; and
updating the noncompliant device with a compliant feature license.

2. The method of claim 1, wherein receiving a feature license comprises receiving a new or modified feature license.

3. The method of claim 2, wherein a user provides the new or modified feature license configuration.

4. The method of claim 1, wherein a feature license management system provides the feature license configuration to the device.

5. The method of claim 1, wherein the generate license request message comprises one or more of a list of features to be licensed and a cryptographic signature of the generate license request message.

6. The method of claim 5, wherein the list of features to be licensed comprises features selected from Boolean and/or capacity features.

7. The method of claim 1, further comprising:
informing a user that there is a feature license request to be processed.

8. The method of claim 7, wherein the feature license request is processed by a centralized licensing system.

9. The method of claim 1, further comprising:
generating the feature license by a centralized licensing system.

10. The method of claim 9, further comprising:
transmitting the feature license to a feature license management system.

11. The method of claim 1, further comprising:
transmitting the feature license to the device.

12. The method of claim 1, wherein the feature license comprises one or more of a unique device identifier, a monotonically increasing sequence number, a list of licensed features, and a cryptographic signature of the feature license.

13. The method of claim 1, wherein updating the noncompliant device with the feature license comprises:
applying the feature license to enable device operations.

14. The method of claim 13, further comprising:
transmitting a feature license status from the device to the feature license management system.

15. The method of claim 14, further comprising:
displaying the feature license status of the device to a user.

16. A system comprising:
a plurality of devices configured to receive and apply feature licenses;
a first server configured to create and store feature license configurations; and
a second server configured to generate feature licenses and communicate with the first server to transmit the feature licenses to the plurality of devices.

17. The system of claim 16, wherein the plurality of devices is further configured to generate feature license requests.

18. The system of claim 16, wherein the plurality of devices is further configured to perform verification of compliance with feature license configurations.

19. The system of claim 16, wherein the first server is configured to instruct the plurality of devices to generate feature license requests.

20. The system of claim 16, wherein the first server and second server comprise separate servers.
